(19) United States
(12) Patent Application Publication
(10) Pub. No.: US 2025/0353391 A1
(43) Pub. Date: Nov. 20, 2025

(54) Efficient Operation of a Four-Switch Buck-Boost Converter

(71) Applicant: SPEED CHARGE, LLC, Carter Lake, IA (US)

(72) Inventors: Inder Kumar Vedula, Boulder, CO (US); Aaron Rogers, Newark, CA (US); Trent Martin, Boulder, CO (US); Nikola Milivojevic, Boulder, CO (US)

(21) Appl. No.: 19/038,289

(22) Filed: Jan. 27, 2025

Related U.S. Application Data
(60) Provisional application No. 63/625,256, filed on Jan. 25, 2024.

(51) Int. Cl. B60L 53/22; B60L 53/53; H02J 7/34; H02M 3/158

(52) U.S. Cl. CPC B60L 53/22; B60L 53/53; H02J 7/342; H02M 3/1582; B60L 2210/10; H02J 2207/20

(57) ABSTRACT

A four-switch buck-boost converter configured to couple to a source battery and a target battery includes an inductor and switches S1, S2, S3, and S4 connected so as to define (i) a buck mode in which the switch S3 is always ON, and the switches S1 and S2 control charging and discharging of the inductor, (ii) a boost mode in which the switch S1 is always ON, and the switches S3 and S4 control the charging and the discharging of the inductor, and (iii) a buck-boost mode in which all of the switches S1, S2, S3, and S4 control the charging and the discharging of the inductor. A controller operates the converter in the buck mode, the boost mode, and the buck-boost mode, when it turns the switch S1 ON at a beginning of a switching cycle, and turns the switch S4 ON at an end of the switching cycle.

### CROSS-REFERENCE TO RELATED APPLICATION

This application claims priority to and the benefit of the filing date of provisional U.S. Patent Application No. 63/625,256 entitled “Efficient Method for Operating 4-Switch Buck-Boost Converter” filed on Jan. 25, 2024. The entire content of the provisional application is hereby expressly incorporated herein by reference

### FIELD OF THE DISCLOSURE

This disclosure relates to high-power charging devices and, more particularly, to managing the charge current in a buck-booster converter for such applications as an electric vehicle (EV).

### BACKGROUND

Charging stations (or simply “chargers”) provide electric power to electric vehicles (EVs), including plug-in hybrid vehicles, that can operate without the use or with limited use of hydrocarbon-based fuels. Installation of conventional charging stations typically requires improvements to infrastructure including upgrades to electrical service and construction of suitable housing. The costs, planning, and time required to install these charging systems can be a deterrent to potential commercial or residential operators. To reduce the installation and operating requirements associated with traditional charging stations, some charging stations include batteries to store energy received from a power source (such as an electric utility power grid) over an extended time interval.

A charging station with a built-in battery can use a four-switch buck-booster DC-to-DC converter to transfer power from the battery of the charging station (or the “stationary battery”) to the battery of the EV. When a charging station with a built-in battery charges the EV car battery, the charger battery voltage decreases as the charger battery discharges, while the EV car battery voltage increases as the EV car battery charges. When the charger battery voltage is higher than the EV car battery voltage, a buck-boost converter of the charging station can operate in the buck mode. When the charger battery voltage is lower than the EV car battery voltage, the converter operates in the boost mode.

When the charger battery voltage is relatively close to the EV battery voltage (e.g., when the difference between these voltages is between 20 and 30), the converter can operate in the buck-boost mode. The charging station continues to charge the EV battery in the buck-boost mode. When operating in the buck-boost mode, the converter operates all four switches within the same switching cycle. The conventional methods for operating a four-switch buck-boost converter are not always efficient in terms of producing the output current.

### SUMMARY

A controller of this disclosure operates the four switches in a buck-boost mode in a manner than results in the highest efficiency, so that for the same output current, the average inductor current results in the lowest value, and the lowest peak-to-peak inductor current ripple.

An example embodiment of these techniques is a system for controlling a charging current while transferring energy from a source battery to a target battery in an electric vehicle (EV). The system comprises a four-switch buck-boost converter configured to couple to the source battery and the target battery and including an inductor, and switches S1, S2, S3, and S4 connected so as to define (i) a buck mode in which the switch S3 is always ON, and the switches S1 and S2 control charging and discharging of the inductor, (ii) a boost mode in which the switch S1 is always ON, and the switches S3 and S4 control the charging and the discharging of the inductor, and (iii) a buck-boost mode in which all of the switches S1, S2, S3, and S4 control the charging and the discharging of the inductor. The system further comprises a controller configured to operate the four-switch buck-boost converter in: (a) the buck mode when voltage V_{g} across the source battery is higher than voltage V_{EV} across the target battery, (b) the boost mode when the voltage V_{g} is lower than the voltage V_{EV}, and (c) the buck-boost mode when the voltages V_{EV} and V_{g} differ less by a predetermined amount, wherein the controller turns the switch S1 ON at a beginning of a switching cycle, and turns the switch S4 ON at an end of the switching cycle.

Another example embodiment of these techniques is a method for operating a four-switch buck-boost converter configured to transfer energy from a source battery to a target battery in an electric vehicle (EV), the four-switch buck-boost converter including an inductor and switches S1, S2, S3, and S4, the method comprising: operating the four-switch buck-boost converter a buck mode when voltage V_{g} across the source battery is higher than voltage V_{EV} across the target battery, including keeping the switch S3 ON, and operating the switches S1 and S2 to control charging and discharging of the inductor; operating the four-switch buck-boost converter a boost mode when the voltage V_{g} is lower than the voltage V_{EV}, including keeping the switch S1 ON, and operating the switches S3 and S4 control the charging and the discharging of the inductor; and operating the four-switch buck-boost converter in a buck-boost mode when the voltages V_{EV} and V_{g} differ less by a predetermined amount, including turning the switch S1 ON at a beginning of a switching cycle, and turning the switch S4 ON at an end of the switching cycle.

Yet another example embodiment of these techniques is a charging station comprising: a source battery; a four-switch buck-boost converter configured to couple to the source battery and a target battery in an electric vehicle (EV), the converter including: an inductor, and switches S1, S2, S3, and S4 connected so as to define (i) a buck mode in which the switch S3 is always ON, and the switches S1 and S2 control charging and discharging of the inductor, (ii) a boost mode in which the switch S1 is always ON, and the switches S3 and S4 control the charging and the discharging of the inductor, and (iii) a buck-boost mode in which all of the switches S1, S2, S3, and S4 control the charging and the discharging of the inductor; and a controller configured to operate the four-switch buck-boost converter in: (a) the buck mode when voltage V_{g} across the source battery is higher than voltage V_{EV} across the target battery, (b) the boost mode when the voltage V_{g} is lower than the voltage V_{EV}, and (c) the buck-boost mode when the voltages V_{EV} and V_{g} differ less by a predetermined amount, wherein the controller turns the switch S1 ON at a beginning of a switching cycle, and turns the switch S4 ON at an end of the switching cycle.

### BRIEF DESCRIPTION OF THE DRAWINGS

FIG. 1A is a block diagram of an example charging site configured for energy management between multiple vehicle charging systems via a DC bus;

FIG. 1B is a block diagram of an example electric vehicle charging system configured for DC charge transfer;

FIGS. 2A-C are block diagrams of example charging sites configured for energy management between multiple vehicle charging systems via a local AC circuit;

FIG. 3 is a block diagram of an example combined electric vehicle charging system configured for both AC and DC charge transfer;

FIG. 4 is a block diagram illustrating a simplified example of a hardware implementation of a controller that can operate in the vehicle charging system of FIGS. 1A-3;

FIG. 5 is a block diagram of an example buck-boost converter that can operate in a charging station of this disclosure;

FIGS. 6A and 6B illustrate example operation of the buck-boost converter of FIG. 5 using trailing-edge pulse width modulation (PWM) with a sawtooth carrier;

FIGS. 7A and 7B illustrate example operation of the buck-boost converter of FIG. 5 using dual-edge PWM with a triangular carrier;

FIGS. 8A and 8B illustrate example operation of the buck-boost converter of FIG. 5 using leading-edge PWM with a sawtooth carrier;

FIGS. 9A and 9B illustrate example operation of the buck-boost converter of FIG. 5 using both trailing edge PWM and leading-edge PWM; and

FIG. 10 is a flow diagram of an example method for operating a four-switch buck-boost converter.

### DETAILED DESCRIPTION OF THE DRAWINGS

The techniques for controlling the charging current are discussed below with reference to charging an EV. However, the buck-boost converter of this disclosure in general can facilitate the charging of battery in a system of any suitable type such as a road vehicle, a two-wheeler, a railway vehicle, a boat, an aerial vehicle, etc. Further, an EV as used in this disclosure also can refer to a hybrid vehicle which includes an internal combustion engine.

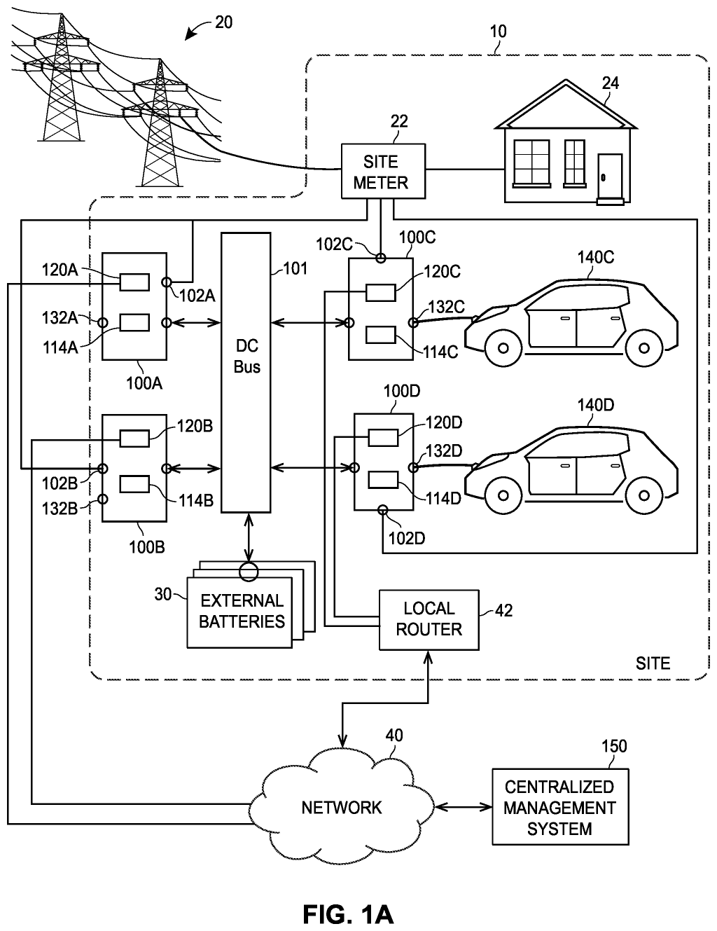

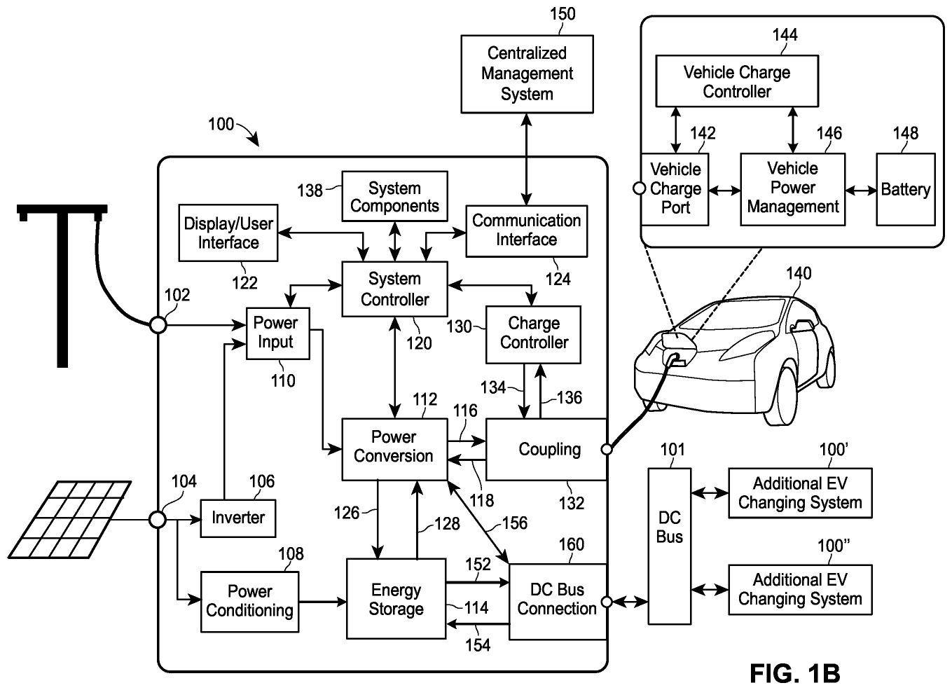

FIG. 1A illustrates a block diagram of an example of a charging site 10 configured for energy management between multiple EV charging systems 100A-D via a DC bus 101. The charging site 10 is supplied with AC power from an electric power grid 20 via a site meter 22, which records power consumption and connects the various electrical components disposed at the charging site 10 to the electric power grid 20. Thus, the electric power grid 20 provides AC power to each of the EV charging systems 100A-D and other electrical components via the site meter 22, including providing AC power to a non-charging load 24 (e.g., commercial building electrical infrastructure) at the charging site 10. In some embodiments, the site meter 22 is a smart meter including additional control logic and communication functionality. For example, the site meter 22 may be configured to communicate with one or more external servers (not show) and/or the centralized management system 150 to obtain demand data regarding load on or demand charges for AC power from the electric power grid 20. In some such embodiments, the site meter 22 may be configured to disconnect part or all of the loads from the electric power grid 20 upon the occurrence of certain conditions (e.g., during peak hours or when the power grid is unstable due to high demand). In this way, the site meter 22 may be used to separate the charging site 10 from the electric power grid 20 when needed. Although only one site meter 22 is shown, some embodiments may include a plurality of meters, each of which may perform part or all of the operation of the site meter 22. Such embodiments may be implemented to facilitate more targeted control of operations of individual EV charging systems 100 or non-charging loads 24 at the charging site 10.

The AC power from the site meter 22 is provided as an input AC electric power to the respective input ports 102A-D of the EV charging systems 100A-D via one or more wired AC connections. In some embodiments, the input AC electric power is received at each of the input ports 102A-D as a 120V or 240V single-phase or three-phase AC power supply. As discussed elsewhere herein, each of the EV charging systems 100A-D converts and stores such input AC electric power to DC power stored in batteries of respective energy storage modules 114A-D, from which charging currents may be provided to vehicles via vehicle couplings 132A-D of the EV charging systems 100A-D. The EV charging systems 100A-D are controlled by respective system controllers 120A-D, which monitor operating data of the respective EV charging systems 100A-D and control charging and discharging of the energy storage modules 114A-D.

In some embodiments, the DC power may be stored in the energy storage modules 114A-D over an interval of time in order to provide charging current to EVs via respective vehicle couplings 132A-D at a faster rate than the input AC electric power is received by the EV charging systems 100A-D. While this has significant advantages in reducing the electrical infrastructure requirements for the charging site 10, some of the EV charging systems 100A-D may be used more that others. For example, EV charging systems 100C and 100D may experience greater use due to closer proximity to a destination (e.g., by being located in a parking lot at locations nearer an entrance to a commercial building). As illustrated, vehicles 140C and 140D may be connected to EV charging systems 100C and 100D by vehicle couplings 132C and 132D, respectively, in order to receive charging currents from energy stored in the energy storage modules 114C and 114D, while no vehicles are charging at EV charging systems 100A and 100B. Thus, the batteries of EV charging systems 100C and 100D will discharge faster than those of EV charging systems 100A and 100B, resulting in a charge imbalance among the energy storage modules 114A-D. To address such an imbalance, energy may be transferred from EV charging systems 100A and 100B to EV charging systems 100C and 100D via the DC bus 101.

The DC bus 101 provides a direct DC power connection between the EV charging systems 100A-D to enable charge transfers among the energy storage modules 114A-D. Each of the EV charging systems 100A-D includes an inter-charger connection (not shown) that provides a bidirectional DC connection to the DC bus 101, and thereby to each of the other EV charging systems 100A-D. Through such inter-charger connections, the EV charging systems 100A-D are enabled to receive and to provide DC current at various times as part of charge transfers, which may be used to perform charge balancing between the energy storage modules 114A-D. In some embodiments, one or more external batteries 30 are also connected to the DC bus 101 to store energy received from the EV charging systems 100A-D and provide the stored energy at a later time, as needed. Such external batteries 30 may include controllers (not shown) to control charging and discharging, or the external batteries 30 may be controlled by the system controllers 120A-D of the EV charging systems 100A-D or by a centralized management system 150. Similarly, in various embodiments, charge transfers may be determined and controlled by the system controllers 120A-D of the EV charging systems 100A-D or by a centralized management system 150. To facilitate such control decisions, each of the system controllers 120A-D is connected via wired or wireless communication connections with the other system controllers 120A-D and/or with the centralized management system 150 to exchange electronic messages or signals.

The centralized management system 150 may communicate with each of the EV charging systems 100A-D in order to monitor operating data regarding the EV charging systems 100A-D and to determine and control charge transfers as needed. The centralized management system 150 may be located at the charging site 10 or at a location remote from the charging site 10. When remote from the charging site 10, the centralized management system 150 may be communicatively connected to the EV charging systems 100A-D via a network 40, which may be a proprietary network, a secure public internet, a virtual private network, or some other type of network, such as dedicated access lines, plain ordinary telephone lines, satellite links, cellular data networks, or combinations of these. In various embodiments, the EV charging systems 100A-D may be communicatively connected with the network 40 directly or via a local router 42. In some embodiments in which the centralized management system 150 is located at the charging site 10, the centralized management system 150 may be combined with or incorporated within any of the EV charging systems 100A-D. In still further embodiments, the centralized management system 150 may be configured as a local cloud or server group distributed across the system controllers 120A-D of the EV charging systems 100A-D in order to provide robust control in the event of a network disruption.

In some embodiments, the centralized management system 150 may also communicate with remote EV charging systems that are deployed in locations remote from the charging site 10, which locations may be separated by large geographic distances. For example, the centralized management system 150 may communicate with EV charging systems 100 located in different parking facilities, on different floors of the same parking structure, or in different cities. Such centralized management system 150 may comprise one or more servers configured to receive operating data from and to send data and/or control commands to each of the EV charging systems 100A-D. To facilitate communication, the centralized management system 150 may be communicatively connected to the system controllers 120A-D of the EV charging systems 100A-D via an electronic communication link with a communication interface module (not shown) within each of the EV charging systems 100A-D.

The centralized management system 150 may group or relate EV charging systems according to their location, their intended function, availability, operating status, and capabilities. The centralized management system 150 may remotely configure and control the EV charging systems, including the EV charging systems 100A-D. The centralized management system 150 may remotely enforce regulations or requirements governing the operation of the EV charging systems 100A-D. The centralized management system 150 may remotely interact with users of the EV charging systems 100A-D. The centralized management system 150 may remotely manage billing, maintenance, and error detection for each of the EV charging systems 100A-D. For example, error conditions resulting in manual disconnection of a vehicle from any of the EV charging systems 100A-D may be reported by such EV charging system to the centralized management system 150 for analysis. The centralized management system 150 may also communicate with mobile communication devices of users of the EV charging systems 100A-D, such as mobile communication devices or other computing devices used by operators of the EV charging systems 100A-D to enable the operator to self-configure the EV charging systems 100A-D, charge pricing, language localization, currency localization, and so on. Operation of the centralized management system 150 in relation to charge transfers between the EV charging systems 100A-D is further described elsewhere herein.

FIG. 1B illustrates a block diagram of an example of an EV charging system 100 configured in accordance with certain aspects disclosed herein. The EV charging system 100 may be any of the EV charging systems 100A-D at the charging site 10 illustrated in FIG. 1A. The EV charging system 100 is configured to receive electric power from a power source (e.g., electric power grid 20) via an input port 102 or 104 in order to charge an energy storage module 114 (e.g., one or more batteries), from which the EV charging system 100 provides a charging current to a vehicle 140 in order to charge a battery 148 of the vehicle 140. Such charge is provided through a vehicle coupling 132, which may comprise a charging cable utilizing one or more standard connector types (e.g., Combined Charging System (CCS) or Charge de Move (CHaDEMO) connectors). In addition to being connected to one or more power sources via the input ports 102 or 104, the EV charging system 100 includes a DC bus connection 160 to the DC bus 101 at the charging site 10. Through the DC bus connection 160, the EV charging system 100 is configured to send DC power to one or more additional EV charging systems 100′ or 100″ and to receive DC power from such additional EV charging systems 100′ or 100″, as controlled by a system controller 120 of the EV charging system 100. Although the illustrated EV charging system 100 is illustrated as communicating with a centralized management system 150, alternative embodiments of the EV charging system 100 need not be configured for such external communication. Additional or alternative components and functionality may be included in further alternative embodiments of charging systems.

The EV charging system 100 includes a power input module 110 having one or more circuits configurable to transform, condition, or otherwise modify power received from an input port 102 or 104 to provide conditioned power to a power conversion module 112. The input power received at input ports 102 or 104 may be received from an electric power grid 20, a local power generator (e.g., a solar panel or a wind turbine), or any other power source. In some embodiments, input AC power is received at an AC input port 102, while input DC power is received at a DC input port 104 (e.g., from photovoltaic cells or other types of DC power sources). The DC input port 104 may be connected to one or more of an inverter module 106 or a power conditioning module 108 for the input DC power. In further embodiments, DC current received via DC input port 104 is converted to an AC current by an inverter module 106, and the AC current is then provided to power input module 110. The power input module 110 may combine AC or DC current received from multiple sources. Similarly, the power input module 110 may direct AC or DC current received from multiple sources to individual circuits or sections of the power conversion module 112. In some embodiments, the power input module 110 may include a rectifier to convert AC current received at an input port 102 or 104 into DC current to be provided to the power conversion module 112. In further embodiments, DC current received via DC input port 104 may instead be provided to a power conditioning module 108 that may include voltage level converting circuits, filters, and other conditioning circuits to provide a charging current to the energy storage module 114.

The power conversion module 112 includes some combination of one or more AC-to-DC, DC-to-DC, and/or DC-to-AC converters for efficient conversion of AC or DC input power received from a power utility or other source at input port 102 or 104 via the power input module 110 to a DC energy storage current 126 provided to the energy storage module 114, which stores the power until needed to provide a charging current 116 to a vehicle 140. In some embodiments, the power conversion module 112 includes an AC-to-DC conversion circuit that generates a DC energy storage current 126 that is provided to an energy storage module 114. Alternatively, the power input module 110 may include an AC-to-DC conversion circuit to generate a DC current from an input AC electric power. In further embodiments, the energy storage module 114 includes high-capacity batteries that have a storage capacity greater than a multiple of the storage capacity in the EVs to be charged (e.g., three times, five times, or ten times an expected vehicle battery capacity). The storage capacity of the energy storage module 114 may be configured based on the expected average charge per charging event, which may depend upon factors such as the types of vehicles charged, the depletion level of the vehicle batteries when charging starts, and the duration of each charging event. For example, a retail parking site may have more charging events of shorter duration, while a commuter train parking lot may have fewer charging events of longer duration. In various embodiments, the storage capacity of the energy storage module 114 may be configured based on maximum expected charging offset by power received from an electric utility. In some embodiments, the storage capacity of each of the energy storage modules 114 of the EV charging systems 100 and any external batteries 30 at a charging site 10 may be configured to ensure a total charge stored at the charging site 10 is sufficient for an expected maximum load due to vehicle charging. In further embodiments, the power received from an electric utility may be limited to power available during low-demand times, such as off-peak or low-priced periods of the day. The power input module 110 may be configured to block or disconnect inflows of power during peak or high-priced periods of the day. In some embodiments, the power input module 110 may be configured to enable power reception during peak periods to ensure continued operation of the EV charging system 100 when power levels in the energy storage module 114 are unexpectedly low.

In some embodiments, the power conversion module 112 may include one or more DC-to-DC conversion circuits that receive DC current 128 at a first voltage level from the energy storage module 114 and drive a charging current 116 to a vehicle 140 through a vehicle coupling 132 to supply a vehicle 140 with the charging current 116 via a vehicle charge port 142. The vehicle coupling 132 serves as an electrical interconnect between the EV charging system 100 and the vehicle 140. In various embodiments, such vehicle coupling 132 comprises a charging head and/or a charging cable. For example, the vehicle coupling 132 may comprise a charging cable having a standard-compliant plug for connection with a vehicle charge port 142 of vehicles 140. The vehicle coupling 132 may include both a power connection for carrying the charging current 116 and a communication connection for carrying electronic communication between the charge controller 130 and the vehicle 140. In some embodiments, the EV charging system 100 may comprise multiple vehicle couplings 132, and the power conversion module 112 may include a corresponding number of DC-to-DC conversion circuits specific to each of the multiple couplings. According to some embodiments, the power conversion module 112 may be further configured to receive a reverse current 118 from a vehicle 140 via the vehicle coupling 132, which reverse current 118 may be used to provide a DC energy storage current 126 to add energy to the energy storage module 114. In some examples, the power conversion module 112 includes one or more inverters that convert the DC current 128 to an AC current that can be provided as the charging current 116.

A charge controller 130 controls the charging current 116 and/or reverse current 118 through each vehicle coupling 132. To control charging or discharging of the vehicle 140, the charge controller 130 comprises one or more logic circuits (e.g., general or special-purpose processors) configured to execute charging control logic to manage charging sessions with vehicle 140. Thus, the charge controller 130 is configured to communicate with the system controller 120 to control the power conversion module 112 to provide the charging current 116 to the vehicle 140 or to receive the reverse current 118 from the vehicle 140 via the vehicle coupling 132. In some instances, the charge controller 130 may include power control circuits that further modify or control the voltage level of the charging current 116 passed through the vehicle coupling 132 to the vehicle 140. The charge controller 130 also communicates via the vehicle coupling 132 with a vehicle charge controller 144 within the vehicle 140 to manage vehicle charging. Thus, the charge controller 130 communicates with the vehicle charge controller 144 to establish, control, and terminate charging sessions according to EV charging protocols (e.g., CCS or CHaDEMO). The charge controller 130 may be communicatively connected with the vehicle coupling 132 to provide output signals 134 to the vehicle charge controller 144 and to receive input signals 136 from the vehicle charge controller 144.

A system controller 120 is configured to control operations of the EV charging system 100 by implementing control logic using one or more general or special-purpose processors. The system controller 120 is configured to monitor and control power levels received by the power input module 110, power levels output through the charging current 116, energy levels in the energy storage module 114, and charge received from or output to the DC bus 101 via the DC bus connection 160. The system controller 120 is further configured to communicate with and control each of the one or more charge controllers 130, as well as controlling the power conversion module 112. For example, the system controller 120 is configured to control the power conversion module 112 and the charge controller to supply a charging current 116 to the vehicle coupling 132 in response to instructions from the charge controller 130. As discussed further herein, the system controller 120 is also configured to control (either separately or in coordination with the centralized management system 150) charge transfers to manage energy levels of the EV charging system 100 in relation to additional EV charging systems 100′ and 100″ at the charging site 10.

The system controller 120 controls charge transfers by determining occurrence of a triggering condition for a charge transfer and controlling a response to such triggering condition in order to provide or receive DC power via a direct connection with one or more additional EV charging systems 100′ or 100″ provided by the DC bus 101. Thus, the system controller 120 controls receiving DC input from and providing DC output to the DC bus 101 via a DC bus connection 160 of the EV charging system 100 in order to effect charge transfers at the charging site 10. The DC bus connection 160 serves as an inter-charger connection of the EV charging system 100 and is configured to connect the EV charging system 100 to the DC bus 101 at the charging site 10 as a direct connection for the exchange of DC power between the EV charging system 100 and additional EV charging systems 100′ and 100″ (e.g., other EV charging systems of the EV charging systems 100A-D) at the charging site 10, as well as with any external batteries 30 at the site 10 (as illustrated in FIG. 1A). In some embodiments, the DC bus connection 160 receives and provides DC power via a DC link 156 with the power conversion module 112, with the power conversion module 112 being controlled by the system controller 120 to manage any voltage or current requirements of the energy storage module 114 or the DC bus 101. In additional or alternative embodiments, the DC bus connection 160 may directly interface with the energy storage module 114 in order to provide a DC output current 152 from the energy storage module 114 to the DC bus 101 and to provide a DC input current 154 from the DC bus 101 to the energy storage module 114, as controlled by the system controller 120.

The system controller 120 is also configured to communicate with other various system components 138 of the EV charging system 100 (e.g., other controllers or sensors coupled to the energy storage module 114 or other components of the EV charging system 100) in order to receive operating data and to control operation of the system via operation of such system components 138. For example, the system controller 120 may monitor temperatures within the EV charging system 100 using the system components 138 and may be further configured to mitigate increases in temperature through active cooling or power reductions using the same or different system components 138. Likewise, the system controller 120 communicates with a user interface module 122 (e.g., a touchscreen display) and a communication interface module 124 (e.g., a network interface controller) to provide information and receive control commands. Each communication interface module 124 may be configured to send and receive electronic messages via wired or wireless data connections, which may include portions of one or more digital communication networks.

The system controller 120 is configured to communicate with the components of the EV charging system 100, including power input module 110, power conversion module 112, the user interface module 122, the communication interface module 124, the charge controller 130, and the system components 138 over one or more data communication links. The system controller 120 may also be configured to communicate with external devices, including a vehicle 140 via the vehicle coupling 132, one or more additional EV charging systems 100′ and 100″ via the centralized management system 150, one or more external batteries 30, or a site meter 22. The system controller 120 may manage, implement or support one or more data communication protocols used to control communication over the various communication links, including wireless communication or communication via a local router 42. The data communication protocols may be defined by industry standards bodies or may be proprietary protocols.

The user interface module 122 is configured to present information related to the operation of the EV charging system 100 to a user and to receive user input. The user interface module 122 may include or be coupled to a display with capabilities that reflect intended use of the EV charging system 100. In one example, a touchscreen may be provided to present details of charging status and user instructions, including instructions describing the method of connecting and disconnecting a vehicle 140. The user interface module 122 may include or be coupled to a touchscreen that interacts with the system controller 120 to provide additional information or advertising. The system controller 120 may include or be coupled to a wireless communication interface that can be used to deliver a wide variety of content to users of the EV charging system 100, including advertisements, news, point-of-sale content for products/services that can be purchased through the user interface module 122. The display system may be customized to match commercial branding of the operator, to accommodate language options and for other purposes. The user interface module 122 may include or be connected to various input components, including touchscreen displays, physical input mechanisms, identity card readers, touchless credit card readers, and other components that interact through direct connections or wireless communications. The user interface module 122 may further support user authentication protocols and may include or be coupled to biometric input devices such as fingerprint scanners, iris scanners, facial recognition systems and the like.

In some embodiments, the energy storage module 114 is provisioned with a large battery pack, and the system controller 120 executes software to manage input received from a power source to the battery pack based upon demand level data (e.g., demand or load data from an electric power grid 20 or site meter 22), such that power is drawn from the power source to charge the battery pack at low-load time periods and to avoid drawing power from the grid during peak-load hours. The software may be further configured to manage power output to provide full, fast charging power in accordance with usage generated by monitoring patterns of usage by the EV charging system 100. The use of historical information can avoid situations in which the battery pack becomes fully discharged or depleted beyond a minimum energy threshold. For example, charging may be limited at a first time based upon a predicted later demand at a second time, which later demand may be predicted using historical information. This may spread limited charging capacity more evenly among vehicle throughout the course of a day or in other situations in which battery pack capacity is expected to be insufficient to fully charge all EVs over a time interval, taking account of the ability to add charge to the energy storage module 114.

In further embodiments, the system controller 120 executes software (either separately or in coordination with the centralized management system 150) to manage energy draw and use by controlling charging and discharging over time among multiple EV charging systems 100 at the charging site 10. Thus, the charge drawn from the power source may be limited or avoided during peak-load hours by charge transfer between the EV charging system 100 and one or more additional EV charging systems 100′ and 100″ via the DC bus 101 at the charging site 10, effectively pooling the energy stored in the batteries of all of the charging systems at the charging site 10. As noted above, in some embodiments, the charging site 10 may include one or more external batteries 30 connected to the DC bus 101. In such embodiments, the systems controller 120 and/or the centralized management system 150 may further manage energy inflow and outflow at the charging site 10 by controlling selective charging and discharging such batteries at appropriate time periods to avoid or reduce total power draw of the charging site 10 from the power source during peak-demand or other high-demand times by charging the batteries of the EV charging systems 100 and the external batteries 30 during low-demand times. In some such embodiments, such energy management enables the EV charging system 100 to continue charging vehicles 140 even when the power source is disconnected or unavailable (e.g., when a local power grid is down). As discussed further elsewhere herein, the systems controllers 120 of the EV charging systems 100 and/or the centralized management system 150 may further manage site-wide energy use by controlling charge transfers based upon differential charge levels or discharge levels associated with differential utilization of the various EV charging system 100 at the charging site 10 in order to effect charge balancing or to ensure sufficient charge availability for charging vehicle 140 at one or more of the EV charging systems 100.

In some embodiments, the EV charging system 100 may be configured with two or more vehicle couplings 132 to enable concurrent charging of multiple vehicles 140. The system controller 120 may be configured by a user via the user interface module 122 to support multiple modes of operation and may define procedures for charge transfer or power distribution that preserve energy levels in the energy storage module 114 when multiple vehicles 140 are being concurrently charged. Charge transfers may be used to transfer power from EV charging systems 100 that have available power or are not being used to charge a vehicle 140 to EV charging systems 100 that are charging one or more vehicles 140. Distribution of power may be configured to enable fast charging of one or more vehicles 140 at the expense of other vehicles 140. In this regard, the vehicle couplings 132 may be prioritized or the system controller 120 may be capable of identifying and prioritizing connected vehicles 140. In some instances, the system controller 120 may be configured to automatically control the respective charge controllers 130 to split available power between two vehicles 140 after the second vehicle 140 is connected. The available power may be evenly split between two vehicles 140 or may be split according to priorities or capabilities. In some examples, the system controller 120 may conduct arbitration or negotiation between connected vehicles 140 to determine a split of charging capacity. A vehicle 140 may request a charging power level at any given moment based on temperature, battery charge level, and other characteristics of the vehicle 140 and its environment and to achieve maximum charge rate and minimum charging time for the current circumstances.

As illustrated, a vehicle 140 may be charged by connecting the vehicle 140 to the EV charging system 100 via a vehicle coupling 132. This may include plugging a charging cable of the EV charging system 100 into a vehicle charge port 142 of the vehicle 140. The vehicle charge port 142 is configured to receive the charging current 116 through the vehicle coupling 132 and provide such received current to a vehicle power management module 146. The vehicle charge port 142 is further configured to provide an electronic communication connection between the vehicle coupling 132 and a vehicle charge controller 144, which controls charging of the vehicle 140. The vehicle power management module 146 is controlled by the vehicle charge controller 144 to provide power to each of one or more batteries 148 of the vehicle 140 in order to charge such battery 148. In some instances, the vehicle charge port 142 includes a locking mechanism to engage and retain a portion of the vehicle coupling 132 in place during charging sessions. For example, for safety reasons, the vehicle charge controller 144 may control a locking mechanism of the vehicle charge port 142 to lock a plug of a charging cable in the vehicle charge port 142 while a charging session is active.

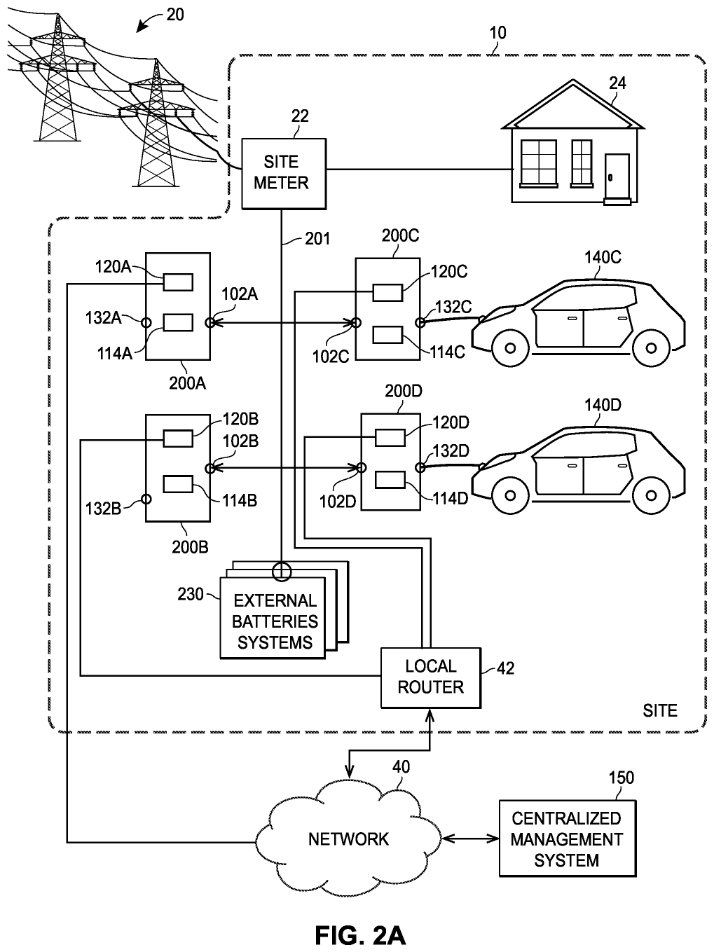

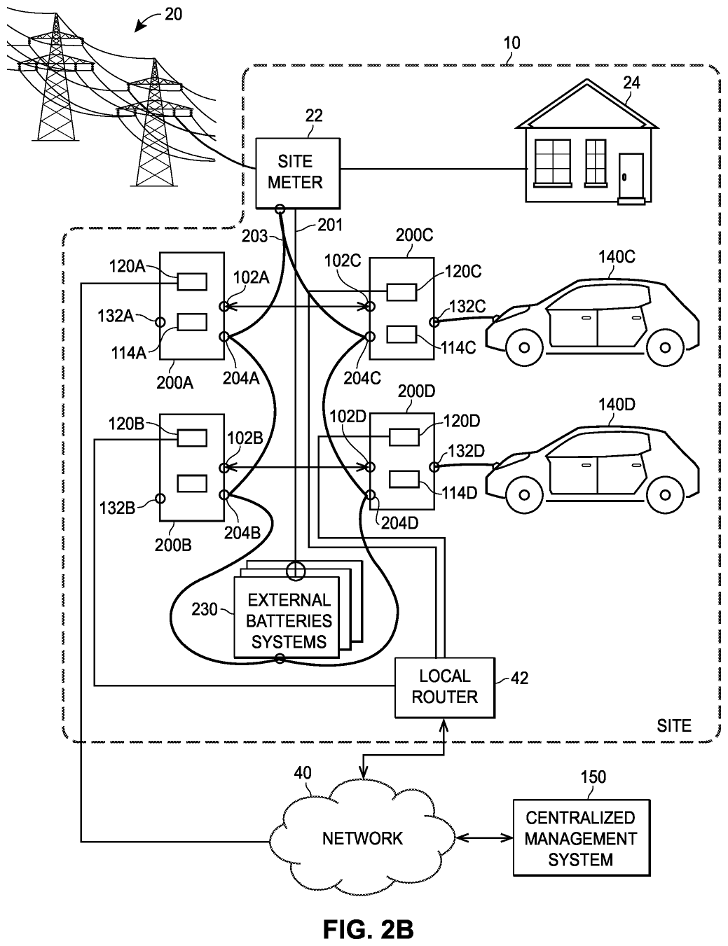

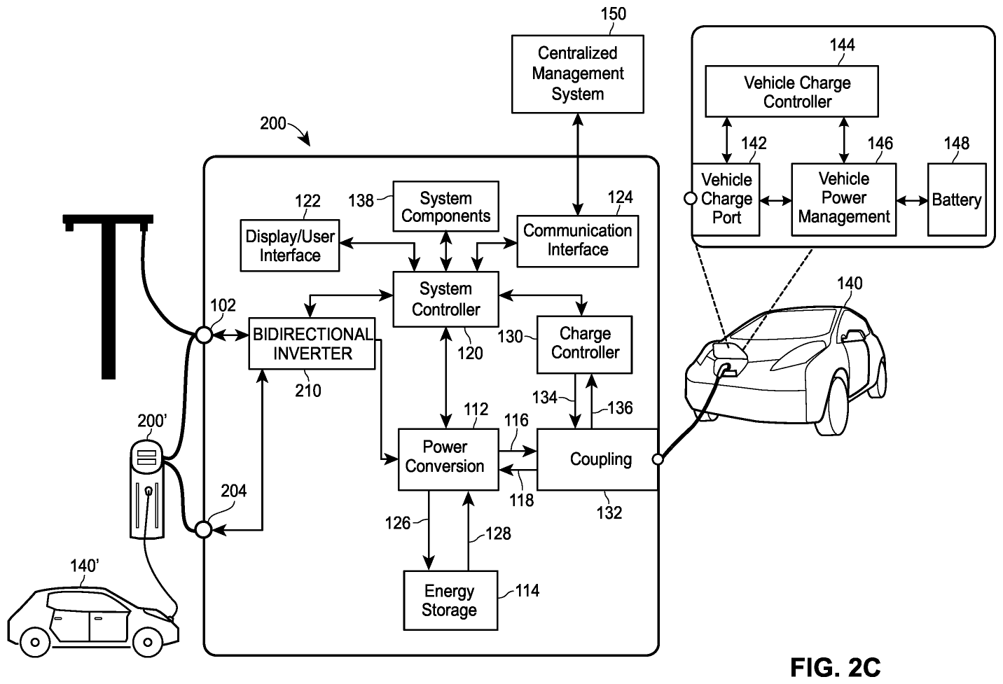

FIGS. 2A-B illustrate block diagrams of examples of a charging site 10 configured for energy management between multiple EV charging systems 200A-D via a local AC circuit 201 or 203. The configurations of the systems and components shown in FIGS. 2A-B are similar to those shown in FIG. 1A, but the EV charging systems 200A-D are configured and connected to transfer charge as AC current over a local AC circuit 201 or 203, rather than as DC current over the DC bus 101. Accordingly, each of the EV charging systems 200A-D receives input AC electric power at respective input ports 102A-D from the electric power grid 20 via the site meter 22 and a local AC circuit 201. The EV charging systems 200A-D rectify the input AC electric power into DC electric power to charge batteries of their respective energy storage modules 114A-D, which may then be used to provide charging currents to vehicles via vehicle couplings 132A-D (as shown with respect to vehicles 140C and 140D). The site meter 22 also provides AC power from the electric power grid 20 to the non-charging load 24 (e.g., commercial building electrical infrastructure) at the charging site 10. Operation of each of the EV charging systems 200A-D is controlled by their respective system controllers 120A-D, which are communicatively connected to the centralized management system 150, either directly or via the network 40, which may include a connection via a local router 42 at the charging site 10.

As discussed elsewhere herein, the EV charging systems 200A-D are configured and controlled by the system controllers 120A-D and/or the centralized management system 150 to transfer charge via local AC circuit 201 or 203 as needed to improve the balance of energy storage and energy demand at each of the EV charging systems 200A-D. To achieve such energy transfers, the DC power provided by one or more of the energy storage modules 114A-D is converted to an AC current by an inverter (not shown) and provided to the local AC circuit 201 or 203 in order to transfer energy to one or more other energy storage modules 114A-D. The respective system controllers 120A-D of the donor EV charging systems 200A-D may be configured to control the phase of the AC output power to the local AC circuit 201 or 203 to match that of the input AC electric power from the site meter 22 or of other donor EV charging systems 200A-D. As noted above, the input AC electric power may be received at each of the input ports 102A-D as a 120V or 240V single-phase or three-phase AC power supply. In various embodiments, the AC output power at input ports 102A-D or input ports 204A-D may be provided according to the same or different voltage and phase combinations.

FIG. 2A illustrates an embodiment in which one local AC circuit 201 carries both the input AC electric power from the electric power grid 20 via the site meter 22 and AC charge transferred between the EV charging systems 200A-D. In such embodiments, the respective input ports 102A-D serve to both receive AC current from the local AC circuit 201 and provide AC current to the local AC circuit 201. In some such embodiments, the local AC circuit 201 may be further connected to one or more non-charging loads 24 at the charging site 10 in order to provide AC power to such non-charging loads 24 when the electric power grid 20 is disconnected or unavailable.

FIG. 2B illustrates an embodiment in which a separate local AC circuit 203 carries AC current for energy transfers among the EV charging systems 200A-D, while the local AC circuit 201 carries the input AC electric power from the electric power grid 20. As illustrated, the local AC circuit 201 may be connected to each of the EV charging systems 200A-D via respective input ports 102A-D, while the local AC circuit 203 may be connected to each of the EV charging systems 200A-D via the respective input ports 204A-D. Such separation of the local AC circuits 201 and 203 may be advantageous in some situations by enabling charge transfers at higher power than the input AC electric power from the electric power grid 20 or while such input AC electric power is being received from the electric power grid 20. In some embodiments, the local AC circuit 203 is also connected to the site meter 22. In some such embodiments, the site meter 22 may receive AC power from the local AC circuit 203 and provide such AC power to one or more non-charging loads 24 at the charging site 10 in order to provide AC power to such non-charging loads 24 when the electric power grid 20 is disconnected or unavailable.

In some embodiments, the local AC circuit 201 and/or 203 also connects one or more external battery systems 230 to the EV charging systems 200A-D in order to increase the storage capacity at the charging site 10. Such external battery systems 230 may receive input AC power from the electric power grid 20 via local AC circuit 201 and/or from the EV charging systems 200A-D via local AC circuit 203 in order to charge one or more batteries (not shown) of the external battery systems 230. Such external battery systems 230 may include various components (not shown), including controllers and bidirectional inverters or separate rectifiers and inverters in order to convert the input AC power into DC power for storage and later convert the stored DC power into output AC power for charge transfers to one or more of the EV charging systems 200A-D.

FIG. 2C illustrates a block diagram of an example of an EV charging system 200 configured in accordance with certain aspects disclosed herein. The EV charging system 200 may be any of the EV charging systems 200A-D at the charging site 10 illustrated in FIGS. 2A-B. The components and configuration of the EV charging system 200 shown in FIG. 2C are similar to those of the EV charging system 100 shown in FIG. 1B, but the EV charging system 200 is configured for transferring charge to an additional EV charging system 200′ as AC current over a local AC circuit 201 or 203 via one or more of the input ports 102 or 104, rather than as DC current over the DC bus 101 via the DC bus connection 160. Accordingly, the power input module 110 of EV charging system 100 is replaced with a bidirectional inverter 210, which is connected to provide DC power to the power conversion module 112 and is further connected to receive input AC power from and to provide output AC power to the input ports 102 and 204. As illustrated, the EV charging system 200 also lacks the inverter module 106 and power conditioning module 108 to receive input DC electrical energy from DC input port 104 of the EV charging system 100, but such components may be included in some embodiments of the EV charging system 200. Other components of the EV charging system 200 are as described above with respect to the EV charging system 100. Additional or alternative components and functionality may be included in further alternative embodiments of charging systems.

The bidirectional inverter 210 is configured to alternatively operate in an inverter mode or in a rectifier mode at various times as controlled by the system controller 120. In the rectifier mode, the bidirectional inverter 210 converts an input AC current from a power source (e.g., the electric power grid 20 or an additional EV charging system 200′ via a local AC circuit 201 or 203) into a DC current to provide to the energy storage module 114 via the power conversion module 112. In the inverter mode, the bidirectional inverter 210 convers a DC current from the energy storage module 114 via the power conversion module 112 into an output AC current to the local AC circuit 201 or 203 via an input port 102 or 204. Thus, when a triggering condition occurs to cause the EV charging system 200 to provide an AC output power to the local AC circuit 201 or 203 to transfer charge to an additional EV charging system 200′ at the charging site 10 (e.g., to enable the additional EV charging system 200′ to charge a vehicle 140′), the bidirectional inverter operates in the inverter mode to convert a DC current from the power conversion module 112 into the AC output power and provide such AC output power to the local AC circuit 201 or 203 via an input port 102 or 204. In some embodiments, a plurality of separate components may instead be configured to perform such functionality of the bidirectional inverter 210, such as by including one or more inverters and rectifiers in the EV charging system 200. In further embodiments, part or all of the functionality of the bidirectional inverter 210 may be incorporated into the power conversion module 112, or part or all of the functionality of the power conversion module 112 may be incorporated into the bidirectional inverter 210.

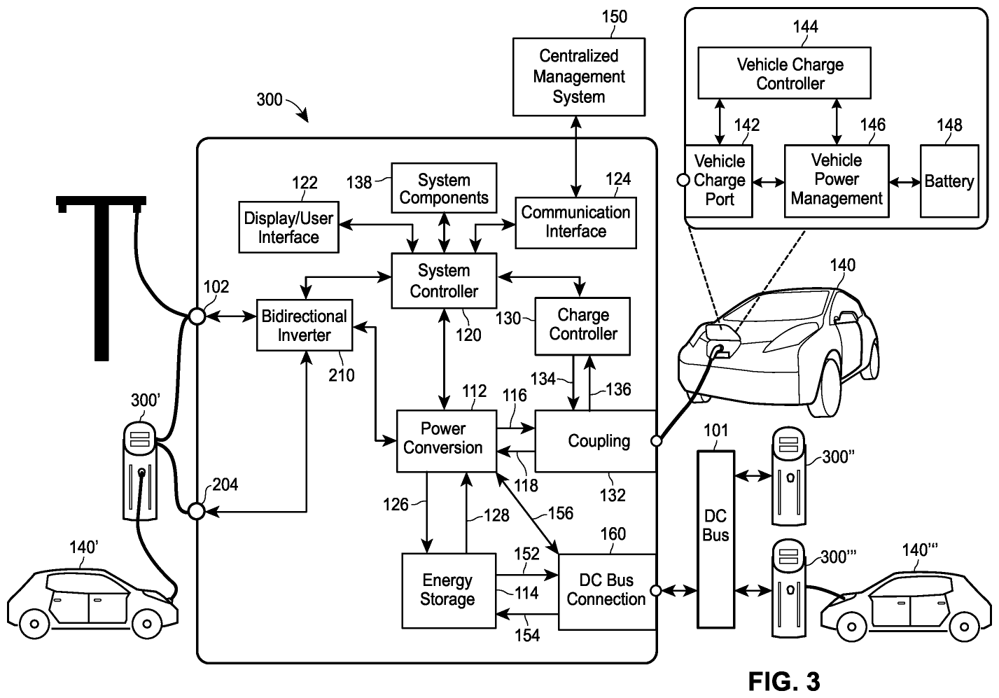

FIG. 3 illustrates a block diagram of an example of a combined EV charging system 300 configured for both AC and DC charge transfer in accordance with certain aspects disclosed herein. The EV charging system 300 may be any of the EV charging systems 100A-D or EV charging systems 200A-D at the charging sites 10 illustrated in FIG. 1A or FIGS. 2A-B. The components and configuration of the EV charging system 300 shown in FIG. 3 combine those of the EV charging system 100 shown in FIG. 1B and those of the EV charging system 200 shown in FIG. 2C. Thus, the EV charging system 300 is configured for transferring charge to additional EV charging system 300′ via a local AC circuit 201 or 203 (e.g., to enable the additional EV charging system 200′ to charge a vehicle 140′) and for transferring charge to additional EV charging systems 300″ and 300″′ via DC bus 101 (e.g., to enable the additional EV charging system 300″′ to charge a vehicle 140″′). As illustrated, the EV charging system 300 includes the bidirectional inverter 210 of EV charging system 200, rather than the power input module 110 of EV charging system 100. As further illustrated, the EV charging system 300 also lacks the inverter module 106 and power conditioning module 108 to receive input DC electrical energy from DC input port 104 of the EV charging system 100, but such components may be included in some embodiments of the EV charging system 300. Other components of the EV charging system 300 are as described above with respect to the EV charging system 100 or EV charging system 200. Additional or alternative components and functionality may be included in further alternative embodiments of charging systems.

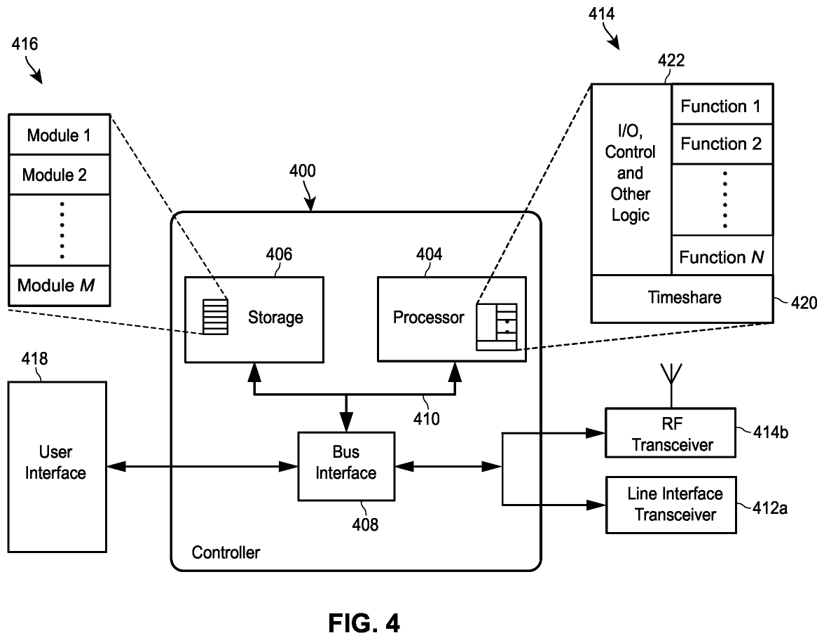

FIG. 4 illustrates a block diagram illustrating a simplified example of a hardware implementation of a controller 400, such as any of the system controller 120, the charge controller 130, the vehicle charge controller 144, or the centralized management system 150 disclosed herein. In some embodiments, the controller 400 may be a controller of a site meter 22, an external battery 30, an external battery system 230, or any other component disclosed herein that implements control logic to control any aspect of the described systems and methods. The controller 400 may include one or more processors 404 that are controlled by some combination of hardware and software modules. Examples of processors 404 include microprocessors, microcontrollers, digital signal processors (DSPs), application-specific integrated circuits (ASICs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 404 may include specialized processors that perform specific functions, which may be configured by one or more of the software modules 416. The one or more processors 404 may be configured through a combination of software modules 416 loaded during initialization and may be further configured by loading or unloading one or more software modules 416 during operation.

In the illustrated example, the controller 400 may be implemented with a bus architecture, represented generally by the bus 410. The bus 410 may include any number of interconnecting buses and bridges depending on the specific application of the controller 400 and the overall design constraints. The bus 410 links together various circuits including the one or more processors 404 and storage 406. Storage 406 may include memory devices and mass storage devices, any of which may be referred to herein as computer-readable media. The bus 410 may also link various other circuits, such as timing sources, timers, peripherals, voltage regulators, and power management circuits. A bus interface 408 may provide an interface between the bus 410 and one or more line interface circuits 412, which may include a line interface transceiver circuit 412a and a radio frequency (RF) transceiver circuit 412b. A line interface transceiver circuit 412a may be provided for each networking technology supported by the controller. In some instances, multiple networking technologies may share some or all of the circuitry or processing modules found in a line interface circuit 412, such as line interface transceiver circuit 412a for wired communication and RF transceiver circuit 412b for wireless communication. Each line interface circuit 412 provides a means for communicating with various other devices over a transmission medium. In some embodiments, a user interface 418 (e.g., touchscreen display, keypad, speaker, or microphone) may also be provided, and may be communicatively coupled to the bus 410 directly or through the bus interface 408.

A processor 404 may be responsible for managing the bus 410 and for general processing that may include the execution of software stored in a computer-readable medium that may include the storage 406. In this respect, the processor 404 of the controller 400 may be used to implement any of the methods, functions, and techniques disclosed herein. The storage 406 may be used for storing data that is manipulated by the processor 404 when executing software, and the software may be configured to implement any of the methods disclosed herein.

One or more processors 404 in the controller 400 may execute software. Software may include instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 406 or in an external computer readable medium. The external computer-readable medium and/or storage 406 may include a non-transitory computer-readable medium. A non-transitory computer-readable medium includes, by way of example, a magnetic storage device (e.g., hard disk, floppy disk, magnetic strip), an optical disk, a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Portions of the computer-readable medium or the storage 406 may reside in the controller 400 or external to the controller 400. The computer-readable medium and/or storage 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 406 may maintain software maintained or organized in loadable code segments, modules, applications, programs, etc., which may be referred to herein as software modules 416. Each of the software modules 416 may include instructions and data that, when installed or loaded on the controller 400 and executed by the one or more processors 404, contribute to a run-time image 414 that controls the operation of the one or more processors 404. When executed, certain instructions may cause the controller 400 to perform functions in accordance with certain methods, algorithms, and processes described herein.

Some of the software modules 416 may be loaded during initialization of the controller 400, and these software modules 416 may configure the controller 400 to enable performance of the various functions disclosed herein. For example, some software modules 416 may configure internal devices or logic circuits 422 of the processor 404, and may manage access to external devices such as line interface circuits 412, the bus interface 408, the user interface 418, timers, mathematical coprocessors, etc. The software modules 416 may include a control program or an operating system that interacts with interrupt handlers and device drivers to control access to various resources provided by the controller 400. The resources may include memory, processing time, access to the line interface circuits 412, the user interface 418, etc.

One or more processors 404 of the controller 400 may be multifunctional, whereby some of the software modules 416 are loaded and configured to perform different functions or different instances of the same function. For example, the one or more processors 404 may additionally be adapted to manage background tasks initiated in response to inputs from the user interface 418, the line interface circuits 412, and device drivers. To support the performance of multiple functions, the one or more processors 404 may be configured to provide a multitasking environment, whereby each of a plurality of functions is implemented as a set of tasks serviced by the one or more processors 404 as needed or desired. In one example, the multitasking environment may be implemented using a timesharing program 420 that passes control of a processor 404 between different tasks, whereby each task returns control of the one or more processors 404 to the timesharing program 420 upon completion of any outstanding operations or in response to an input such as an interrupt. When a task has control of the one or more processors 404, the processing circuit is effectively specialized for the purposes addressed by the function associated with the controlling task. The timesharing program 420 may include an operating system, a main loop that transfers control on a round-robin basis, a function that allocates control of the one or more processors 404 in accordance with a prioritization of the functions, or an interrupt-driven main loop that responds to external events by providing control of the one or more processors 404 to a handling function.

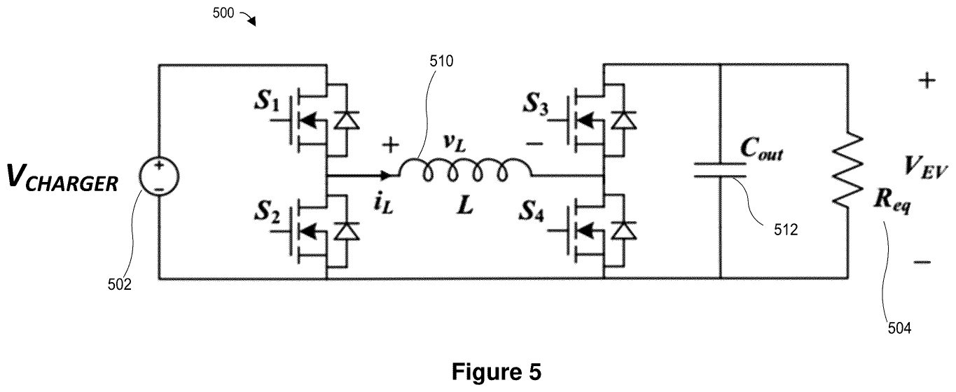

Next, FIG. 5 is a simplified diagram of a buck-booster converter 500 that has a four-switch topology. The buck-booster converter can electrically connect to an input or voltage source 502, which can correspond to the stationary battery of a charging station (e.g., the EV charging system 100A-D, 200A-D, 300, or 400 discussed above), with the voltage V_{CHARGER}, and to an ouput or load 504, which can correspond to the stationary battery of a charging station (e.g., the battery 148 discussed above), with the voltage V_{EV}. The buck-booster converter 500 includes an inductor 510 with inductance L, a capacitor 512 with capacitance C_{OUT}, and switches S1-S4, which can be implemented as metal-oxide-semiconductor field-effect transistors (MOSFETs), for example.

In operation, the switches S1-S4 control the flow of power and the mode of operation (buck, boost, buck-boost) of the buck-booster converter 500. A (micro) controller such as the controller 120A-D, 130, or 400 can generate pulse width modulation (PWM) or enhanced PWM (ePWM) signals for the switches S1-S4, so that the PWM control of switches S1 and S2 defines the buck mode, and the PWM control of switches S3 and S4 defines the boost mode.

Thus, the input to the buck-boost converter 500 is a stationary batter with voltage V_{CHARGER}, and the output is an EV battery with voltage V_{EV}. In the buck mode of operation of the buck-booster converter 500, V_{CHARGER}>V_{EV}. In the boost mode of operation, V_{CHARGER}<V_{EV}. The buck-boost is a transitional mode, during which there are possibilities: V_{CHARGER}>V_{EV} or V_{CHARGER}<V_{EV}.

In the buck mode of operation of the buck-boost converter 500, V_{CHARGER}>V_{EV}, and switch S3 is always in ON (i.e., operates as a pass-through switch), and switch S4 is always OFF. There are two operational states in the buck mode: (i) State 1, when switch S1 is ON, and the buck-boost converter 500 charges the inductor 510, and (ii) State 2, when switch S2 is ON, and the buck-boost converter 500 discharges the inductor 510. In the boost mode of operation of the buck-boost converter 500, V_{CHARGER}<V_{EV}, and switch S1 is always in ON (i.e., operates as a pass-through switch), switch S2 is always OFF. There are two operational states in the boost mode: (i) State 1, when switch S4 is ON, and the buck-boost converter 500 charges the inductor 510, and (ii) State 2, when switch S3 is ON, and the buck-boost converter 500 discharges the inductor 510.

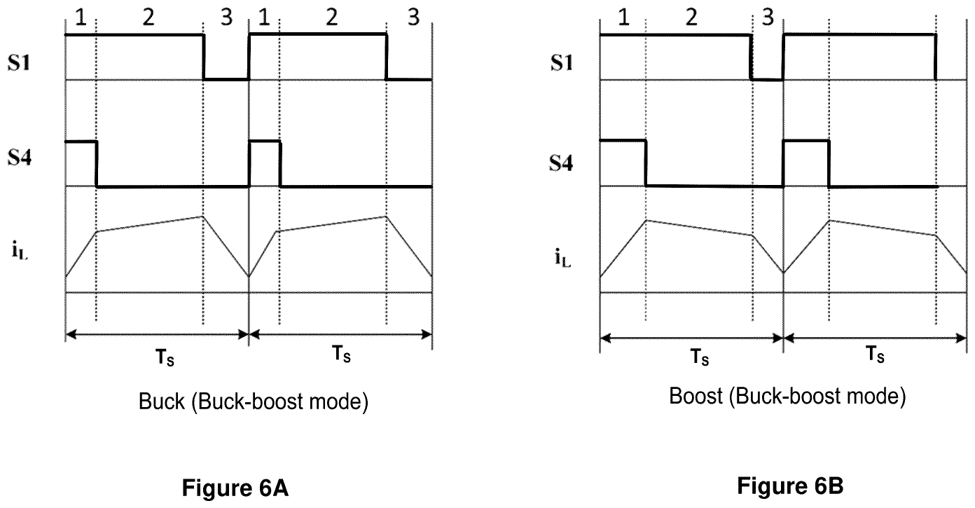

Referring to FIG. 6A, one example technique for operating the buck-boost converter 500 involves trailing-edge pulse width modulation (PWM) with a sawtooth carrier. A switching interval Tₛ can be understood as including three regions: region 1, when S1 and S4 are ON, and S2 and S3 are OFF; region 2, when S1 and S3 are ON, and S2 and S4 are OFF; and region 2, when S2 and S3 are ON, and S2 and S4 are OFF.

The average values of the inductor current can be calculated as:

$${I}_{L\_avg} = \frac{{i}_{o}}{( 1 - {d}_{boost} )} - \frac{{v}_{g} {d}_{boost} ( 1 - {d}_{buck} ) ( {d}_{buck} - {d}_{boost} ) {T}_{s}}{2 L ( 1 - {d}_{boost} )}$$

where iₒ is the load current or the output current charging the EV, v_{g} is the input voltage (or charger battery voltage V_{CHARGER}), d_{buck} is the duty cycle of the buck switch S₁, d_{boost} is the duty cycle of the boost switch S₄, and Tₛ is the switching time period and L is the filter inductance value per phase.

The peak-to-peak inductor current ripple can be calculated as follows:

$${I}_{rippple} = \frac{{v}_{o}}{L} ( 1 - {d}_{buck} ) {T}_{s}$$

where vₒ is the output voltage, or the voltage V_{EV} of the EV battery while the EV battery is charging.

When the buck-boost converter 500 operates the buck-boost mode, S1 and S4 turn ON at the beginning of the switching interval, followed by S1, S3, and then followed by S2, S3, which are complementary to S1 and S4, respectively.

In the buck-boost mode, while the charger battery voltage V_{CHARGER} is higher than the EV car battery voltage V_{EV}, the operation of the switches follows the buck pattern as illustrated in FIG. 6A. However, when the EV car battery V_{EV} is at a higher voltage than the charger battery voltage V_{CHARGER}, the pattern of the switch operation changes to boost, as illustrated in FIG. 6B.

In particular, FIG. 6A illustrates the buck pattern with region 1 (when S1 and S4 are ON, and S2 and S3 are OFF), region 2 (when S1 and S3 are ON, and S2 and S3 are OFF), and region 3 (when S2 and S3 are ON, and S1 and S4 are OFF). FIG. 6B illustrates the boost pattern with region 1 (when S1 and S4 are ON, and S2 and S3 are OFF), region 2 (when S1 and S3 are ON, and S2 and S3 are OFF), and region 3 (when S2 and S3 are ON, and S1 and S4 are OFF). The buck operation illustrated in FIG. 6A is associated with the rising (positive) slope of the inductor current, and the boost operation illustrated in FIG. 6B is associated with the falling (negative) slope of the inductor current.

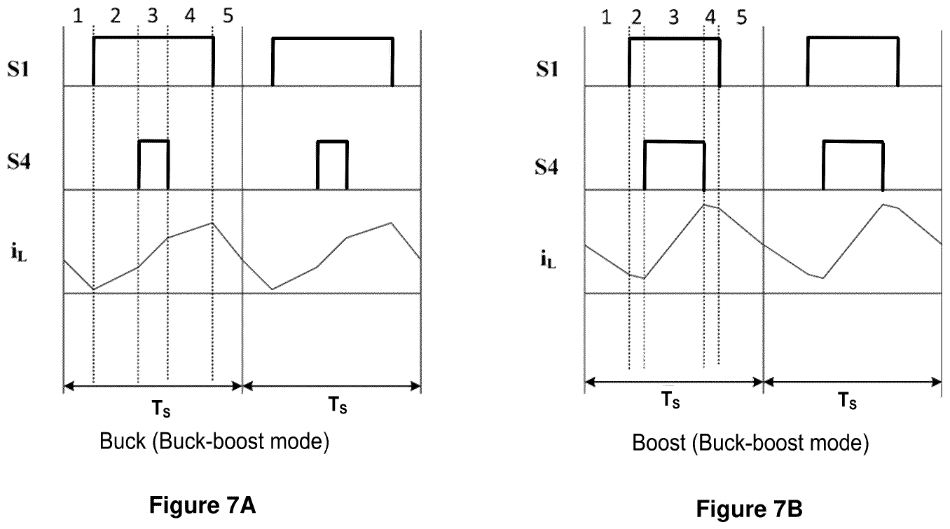

Next, FIGS. 7A and 7B illustrate example operation of the buck-boost converter 500 using dual-edge PWM modulation with a triangular carrier. Here, both S1 and S4 turn ON in the middle of the switching interval.

The patterns in FIGS. 7A and 7B include region 1 (when S2 and S3 are ON, and S1 and S4 are OFF), region 2 (when S1 and S3 are ON, and S2 and S4 are OFF), region 3 (when S1 and S4 are ON, and S2 and S3 are OFF), region 4 (when S1 and S3 are ON, and S2 and S4 are OFF), and region 5 (when S2 and S3 are ON, and S1 and S4 are OFF). The buck operation illustrated in FIG. 7A is associated with the rising (positive) slope of the inductor current, and the boost operation illustrated in FIG. 7B is associated with the falling (negative) slope of the inductor current.

The average values of the inductor current can be calculated as:

$${I}_{L\_avg} = \frac{{i}_{o}}{( 1 - {d}_{boost} )} - \frac{( {v}_{g} - {v}_{o} ) ( 1 - {d}_{buck} ) {( {d}_{buck} - {d}_{boost} )}^{2} {T}_{s}}{4 L ( 1 - {d}_{boost} )}$$

where iₒ is the load current or the output current charging the EV, vg is the input voltage (or charger battery voltage V_{CHARGER}), d_{buck} is the duty cycle of the buck switch S₁, d_{boost} is the duty cycle of the boost switch S₄, and Tₛ is the switching time period and L is the filter inductance value per phase.

The peak-to-peak inductor current ripple can be calculated as follows:

$${I}_{rippple} = \frac{{v}_{o}}{L} ( 1 - {d}_{buck} ) {T}_{s}$$

where vₒ is the output voltage, or the voltage V_{EV} of the EV battery while the EV battery is charging.

As illustrated in FIGS. 7A and 7B, while the charger battery voltage V_{CHARGER} is higher than the EV car battery voltage V_{EV}, the operation of the switches follows the buck pattern as illustrated in FIG. 7A. However, when the EV car battery V_{EV} is at a higher voltage than the charger battery voltage V_{CHARGER}, the pattern of the switch operation changes to boost, as illustrated in FIG. 7B.

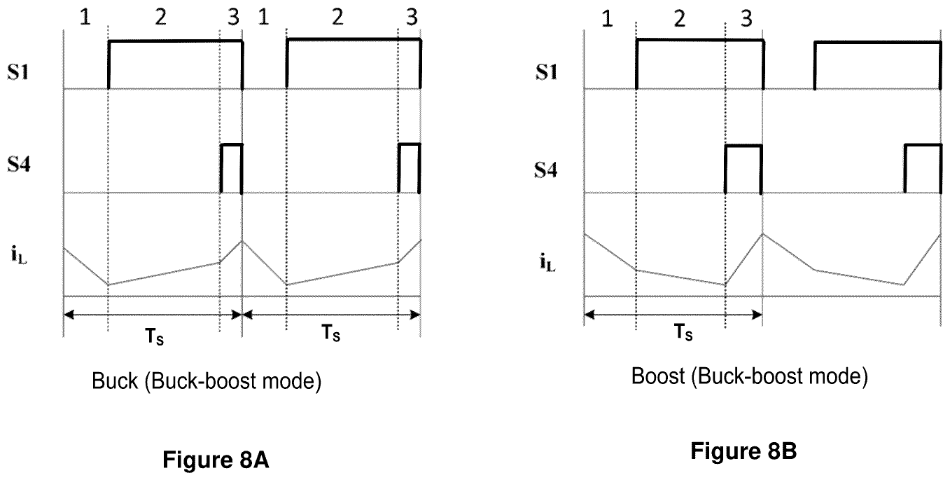

FIGS. 8A and 8B illustrate example operation of the buck-boost converter 500 using leading-edge PWM modulation with a sawtooth carrier. Here, both S1 and S4 turn ON at the end of the switching interval.

The pattern of FIGS. 8A and 8B include region 1 (when S2 and S3 are ON, and S1 and S4 are OFF), region 2 (when S1 and S3 are ON, and S2 and S4 are OFF), and region 3 (when S1 and S4 are ON, and S2 and S3 are OFF). The buck operation illustrated in FIG. 8A, when S1 and D3 are ON, is associated with the rising (positive) slope of the inductor current, and the boost operation illustrated in FIG. 8B is associated with the falling (negative) slope of the inductor current.

The average values of the inductor current can be calculated as:

$${I}_{L\_avg} = \frac{{i}_{o}}{( 1 - {d}_{boost} )} - \frac{{v}_{g} {d}_{boost} ( 1 - {d}_{buck} ) ( {d}_{buck} - {d}_{boost} ) {T}_{s}}{2 L ( 1 - {d}_{boost} )}$$

where iₒ is the load current or the output current charging the EV, v_{g} is the input voltage (or charger battery voltage V_{CHARGER}), d_{buck} is the duty cycle of the buck switch S₁, d_{boost} is the duty cycle of the boost switch S₄, and Tₛ is the switching time period and L is the filter inductance value per phase.

The peak-to-peak inductor current ripple can be calculated as follows:

$${I}_{rippple} = \frac{{v}_{o}}{L} ( 1 - {d}_{buck} ) {T}_{s}$$

where vₒ is the output voltage, or the voltage V_{EV} of the EV battery while the EV battery is charging.

While the charger battery voltage V_{CHARGER} is higher than the EV car battery voltage V_{EV}, the operation of the switches follows the buck pattern as illustrated in FIG. 8A. However, when the EV car battery V_{EV} is at a higher voltage than the charger battery voltage V_{CHARGER}, the pattern of the switch operation changes to boost, as illustrated in FIG. 8B.

Next, an example efficient technique for operating a four-switch buck-boost converter, which yields reduced root mean square (RMS) values for the inductor current and peak-to-peak inductor current ripple.

According to this technique, a (micro) controller such as the controller 120A-D, 130, or 400 causes S1 to turn ON at the beginning of a switching cycle and S4 to turn ON at the end of a switching cycle. The buck PWM signals operate based on trailing edge modulation, while the boost PWM signals s operate based on leading edge modulation.

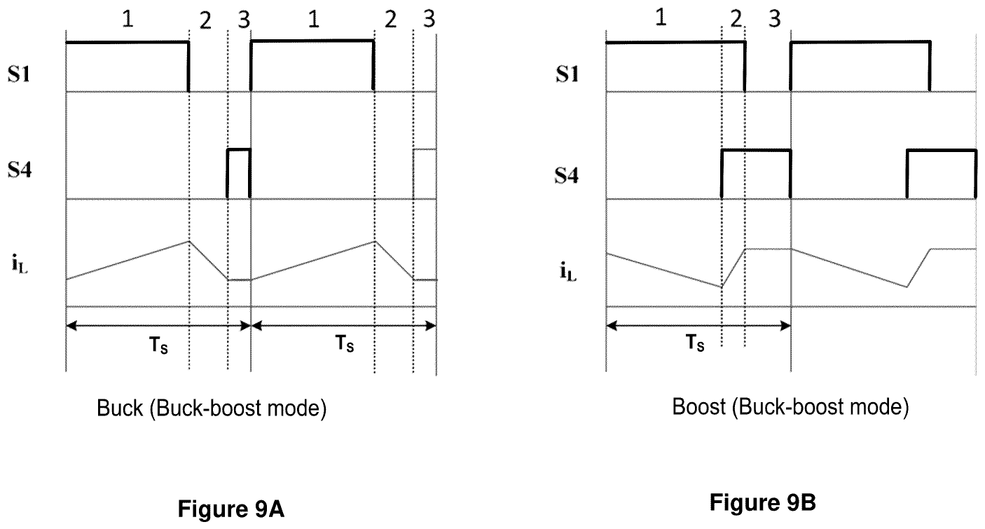

In particular, the pattern of FIGS. 9A and 9B include region 1 (when S1 and S3 are ON, and S2 and S4 are OFF). For region 2, S2 and S3 are ON, and S1 and S4 are OFF in buck mode; and S1 and S4 are ON, and S2 and S3 are OFF in boost mode. Lastly, for region 3, S2 and S4 are ON, and S1 and S3 are OFF. The buck operation illustrated in FIG. 9A, when S1 and S3 are ON, is associated with the rising (positive) slope of the inductor current, and the boost operation illustrated in FIG. 9B, when S1 and S3 are ON, is associated with the falling (negative) slope of the inductor current.

The average values of the inductor current can be calculated as:

$${I}_{L\_avg} = \frac{{i}_{o}}{( 1 - {d}_{boost} )} - \frac{( {v}_{g} - {v}_{o} ) {d}_{boost} {d}_{buck} {T}_{s}}{2 L}$$

where iₒ is the load current or the output current charging the EV, v_{g} is the input voltage (or charger battery voltage V CHARGER), d_{buck} is the duty cycle of the buck switch S₁, d_{boost} is the duty cycle of the boost switch S₄, and Tₛ is the switching time period and L is the filter inductance value per phase.

The peak-to-peak inductor current ripple can be calculated as follows:

$${I}_{rippple} = \frac{{v}_{o}}{L} ( 1 - {d}_{buck} - {d}_{boost} ) {T}_{s}$$

While the charger battery voltage V_{CHARGER} is higher than the EV car battery voltage V_{EV}, the operation of the switches follows the buck pattern as illustrated in FIG. 9A. However, when the EV car battery V_{EV} is at a higher voltage than the charger battery voltage V_{CHARGER}, the pattern of the switch operation changes to boost, as illustrated in FIG. 9B.

As illustrated in FIGS. 9A and 9B, both switches S2 and S4 are on, in region 3 which cane be understood as the “freewheeling” period for the inductor current. Thus, the approach illustrated in FIGS. 9A and 9B significantly reduces the peak-to-peak ripple current. Notably, none of the modulation techniques discussed above with reference to FIGS. 6A-8B (i.e., the trailing edge PWM modulation of FIGS. 6A-B, the dual-edge PWM modulation with triangular carrier of FIGS. 7A-B, or the leading edge PWM modulation of FIGS. 8A-B) includes this region in the corresponding pattern. The technique of FIGS. 9A-B achieves the lowest average inductor current for the same output current and minimum peak-to-peak current ripple, which yields higher efficiency in the buck-boost mode of operation of the four-switch buck-boost converter.

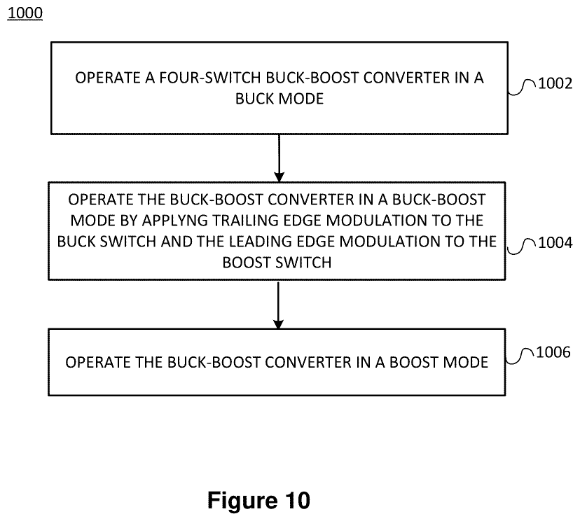

Now referring to FIG. 10, an example method 1000 can be implemented in a controller such as the controller 120A-D, 130, or 400. First, at block 1002, the controller operates a four-switch buck-boost converter (e.g., the converter 500) in the buck mode. Next, at block 1004, the controller operates the four-switch buck-boost converter in a buck-boost mode. The controller controls the buck switch (e.g., the switch S1 of the converter 500) using trailing edge modulation, and controls the boost switch (e.g., the switch S4 of the converter 500) using leading edge modulation. Finally, at block 1006, the controller operates the four-switch buck-boost converter in the boost mode.

### Additional Considerations

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

1. A system for controlling a charging current while transferring energy from a source battery to a target battery in an electric vehicle (EV), the system comprising:
a four-switch buck-boost converter configured to couple to the source battery and the target battery and including:
an inductor, and
switches S1, S2, S3, and S4 connected so as to define (i) a buck mode in which the switch S3 is always ON, and the switches S1 and S2 control charging and discharging of the inductor, (ii) a boost mode in which the switch S1 is always ON, and the switches S3 and S4 control the charging and the discharging of the inductor, and (iii) a buck-boost mode in which all of the switches S1, S2, S3, and S4 control the charging and the discharging of the inductor; and
a controller configured to operate the four-switch buck-boost converter in:
(a) the buck mode when voltage V_{g} across the source battery is higher than voltage V_{EV} across the target battery,
(b) the boost mode when the voltage V_{g} is lower than the voltage V_{EV}, and
(c) the buck-boost mode when the voltages V_{EV} and V_{g} differ less by a predetermined amount, wherein the controller turns the switch S1 ON at a beginning of a switching cycle, and turns the switch S4 ON at an end of the switching cycle.

2. The system of claim 1, wherein the controller applies, in the buck-boost mode:
(i) trailing edge pulse width modulation (PWM) to operate the switch S1, and
(ii) leading edge PWM to operate the switch S4.

3. The system of claim 1, wherein the switching cycle includes a region in which the switches S2 and S4 are ON, and the switches S1 and S3 are OFF.

4. The system of claim 1, wherein the switching cycle includes:
a first region in which the switches S1 and S3 are ON, and the switches S2 and S4 are OFF;
a second region in which the switches S2 and S3 are ON, and the switches S1 and S4 are OFF; and
a third region in which the switches S2 and S4 are ON, and the switches S1 and S3 are OFF.

5. The system of claim 4, wherein the first region has a longer duration than the third region.

6. The system of claim 4, wherein a slope of an inductor current in the third region is substantially zero.

7. The system of claim 4, wherein a slope of an inductor current in the first region is positive when V_{g}>V_{EV}.

8. The system of claim 4, wherein a slope of an inductor current in the first region is negative when V_{g}<V_{EV}.

9. The system of claim 1, wherein the predetermined amount by which the voltages V_{EV} and V_{g} differ in the buck-boost mode is between 20V and 30V.

10. A method for operating a four-switch buck-boost converter configured to transfer energy from a source battery to a target battery in an electric vehicle (EV), the four-switch buck-boost converter including an inductor and switches S1, S2, S3, and S4, the method comprising:
operating the four-switch buck-boost converter a buck mode when voltage V_{g} across the source battery is higher than voltage V_{EV} across the target battery, including keeping the switch S3 ON, and operating the switches S1 and S2 to control charging and discharging of the inductor;
operating the four-switch buck-boost converter a boost mode when the voltage V_{g} is lower than the voltage V_{EV}, including keeping the switch S1 ON, and operating the switches S3 and S4 control the charging and the discharging of the inductor; and
operating the four-switch buck-boost converter in a buck-boost mode when the voltages V_{EV} and V_{g} differ less by a predetermined amount, including:
turning the switch S1 ON at a beginning of a switching cycle, and
turning the switch S4 ON at an end of the switching cycle.

11. The method of claim 10, wherein the operating of the four-switch buck-boost converter in the buck-boost mode includes:
(i) applying trailing edge pulse width modulation (PWM) to the switch S1, and
(ii) applying leading edge PWM to the switch S4.

12. The method of claim 10, wherein the switching cycle includes a region in which the switches S2 and S4 are ON, and the switches S1 and S3 are OFF.

13. The method of claim 10, wherein the switching cycle includes:
a first region in which the switches S1 and S3 are ON, and the switches S2 and S4 are OFF;
a second region in which the switches S2 and S3 are ON, and the switches S1 and S4 are OFF; and
a third region in which the switches S2 and S4 are ON, and the switches S1 and S3 are OFF.

14. The method of claim 13, wherein the first region has a longer duration than the third region.

15. The method of claim 13, wherein a slope of an inductor current in the third region is substantially zero.

16. The method of claim 13, wherein a slope of an inductor current in the first region is positive when V_{g}>V_{EV}.

17. The method of claim 13, wherein a slope of an inductor current in the first region is negative when V_{g}<V_{EV}.

18. The method of claim 10, wherein the predetermined amount by which the voltages V_{EV} and V_{g} differ in the buck-boost mode is between 20V and 30V.

19. A charging station comprising:
a source battery;
a four-switch buck-boost converter configured to couple to the source battery and a target battery in an electric vehicle (EV), the converter including:
an inductor, and
switches S1, S2, S3, and S4 connected so as to define (i) a buck mode in which the switch S3 is always ON, and the switches S1 and S2 control charging and discharging of the inductor, (ii) a boost mode in which the switch S1 is always ON, and the switches S3 and S4 control the charging and the discharging of the inductor, and (iii) a buck-boost mode in which all of the switches S1, S2, S3, and S4 control the charging and the discharging of the inductor; and
a controller configured to operate the four-switch buck-boost converter in:
(a) the buck mode when voltage V_{g} across the source battery is higher than voltage V_{EV} across the target battery,
(b) the boost mode when the voltage V_{g} is lower than the voltage V_{EV}, and
(c) the buck-boost mode when the voltages V_{EV} and V_{g} differ less by a predetermined amount, wherein the controller turns the switch S1 ON at a beginning of a switching cycle, and turns the switch S4 ON at an end of the switching cycle.

20. The system of claim 19, wherein the controller applies, in the buck-boost mode:
(i) trailing edge pulse width modulation (PWM) to operate the switch S1, and
(ii) leading edge PWM to operate the switch S4.
